(19) United States
(12) Patent Application Publication
(10) Pub. No.: US 2004/0216630 A1
(43) Pub. Date: Nov. 4, 2004

(54) Method and apparatus for changing print length on a printing press

(75) Inventors: Dan Zimich, Westchester, IL (US); Dan Machaj, Clarendon Hills, IL (US)

Correspondence Address: MARSHALL, GERSTEIN & BORUN LLP, 6300 SEARS TOWER, 233 S. WACKER DRIVE, CHICAGO, IL, 60606, US

(73) Assignee: Goss International Corp., Bolingbrook, IL

(21) Appl. No.: 10/795,173

(22) Filed: Mar. 5, 2004

Related U.S. Application Data
(60) Provisional application No. 60/452,386, filed on Mar. 6, 2003.

(51) Int. Cl. B41F 5/16

(52) U.S. Cl. 101/479

(57) ABSTRACT

To modify an existing printing press from its original length/cut off to a different cut off, a sub-frame may be mounted on an existing frame of a printing press. The sub-frame permits the relocation of bearing supports for various printing cylinders, such as, for example, the plate cylinders and blanket cylinders. In addition to mounting the sub-frame on the existing frame, new plate and blanket cylinders having different sizes than the plate and blanket cylinders used in the existing printing press may be mounted in the sub-frame to provide different printing lengths/cut offs. Suitable sleeves, such as the eccentric mounting sleeves may be provided as necessary in order to mount the cylinders to the sub-frame.

### RELATED APPLICATIONS

This application claims priority from U.S. Provisional Application Ser. No. 60/452,386, filed Mar. 6, 2003.

### FIELD OF THE DISCLOSURE

The present disclosure relates to printing presses and, more particularly, to a method and apparatus for changing the printing length/cutoff of an existing printing press to a new printing length/cutoff.

### BACKGROUND OF THE DISCLOSURE

In many large scale printing presses one of many factors that affect overall cost is the length of the printing operation, terned the printing length or cutoff. For example, a printing press having a relatively long printing length may require significantly more paper than a press with a shorter printing length. The additional paper required impacts the operational cost of the printing press, which ultimately has an effect on the competitiveness of the printing operation. It is known that certain printing presses may be replaced with more modern and cost-effective printing presses or with presses having a shorter cutoff. However, it is also known that the wholesale replacement of a printing press involves, at the very least, substantial capital expenditures and the incursion of significant labor costs, which costs may not be recovered for a significant length of time.

### BRIEF DESCRIPTION OF THE DRAWINGS

FIG. 1 is an elevational view of a printing station in a printing press having installed thereon an apparatus for changing the printing length/cutoff of the printing press assembled in accordance with the teachings of the present disclosure; and

FIG. 2 is a fragmentary top plan view illustrating an exemplary manner by which a cylinder may be mounted to and installed or removed from an exemplary sub-frame attached to the existing frame of the printing press.

### DETAILED DESCRIPTION

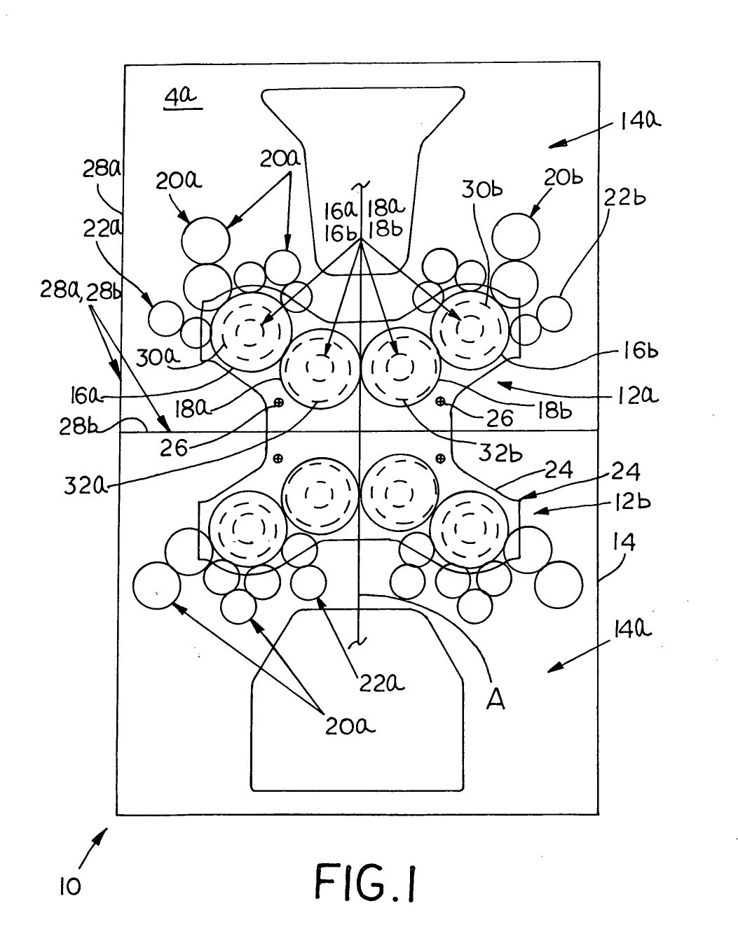

Referring now to FIG. 1, a printing press 10 is shown. It will be understood that the printing press 10 may include a plurality of printing stations, however only a pair of printing stations 12a and 12b are shown. The printing press 10 includes a frame 14 which generally supports a number of printing cylinders, components, systems, and subsystems to be discussed below that form a part of the printing operation.

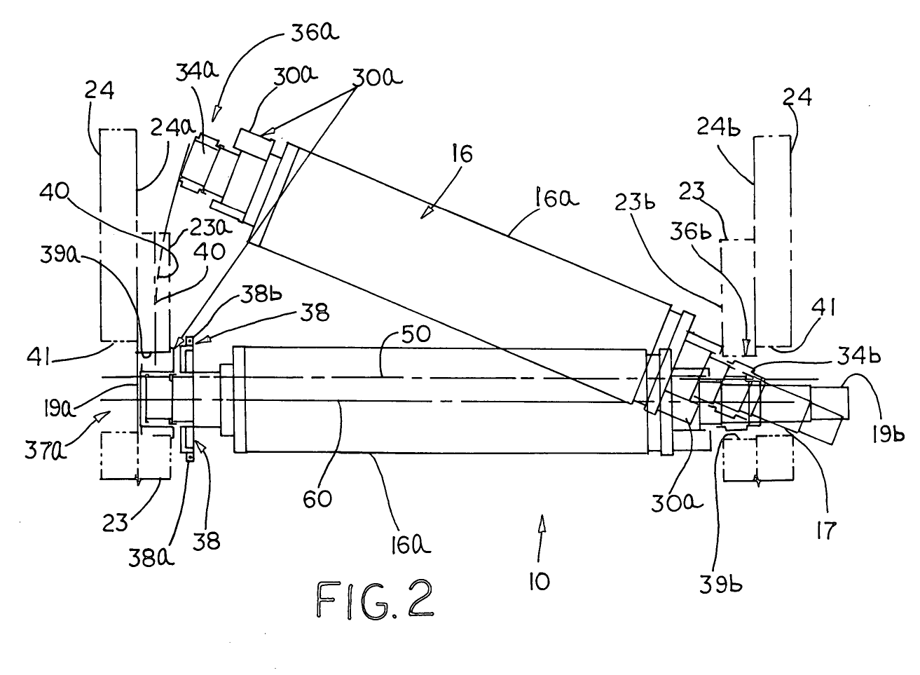

Referring to FIGS. 1 and 2, the frame 14 typically includes a pair of spaced apart sides 14a and 14b. Each side 14a and 14b may include a number of bores 37a and 37b, respectively. Each pair of the bores 37a and 37b have a common bore axis 50 to support a print cylinder. The printing press 10 further includes a sub-frame 24 that similarly includes a pair of spaced apart sides 24a and 24b. Each side 24a and 24b may include a number of bores 39a and 39b, respectively. Each pair of the bores 39a and 39b have a common bore axis 60 to support a print cylinder.

The bores 37a and 37b of the frame 14 are positioned on the frame relative to each other to provide operational coupling of print cylinders that have a first print length. The bores 39a and 39b of the sub-frame 24 are positioned on the sub-frame relative to each other to provide operational coupling of print cylinders that have a different print length than the first print length, which will be referred to as the second print length. As shown in FIG. 2, when the sub-frame 24 is mounted to the frame 14, the bores 39a and 39b of the sub-frame 24 may non-concentrically align with the bores 37a and 37b of the frame 14. In other words, the common bore axis 50 of the frame 14 and the common bore axis of the sub-frame 60 may not align when the sub-frame 24 is mounted to the frame 14. Therefore, as will be described in the following, by mounting the sub-frame 24 to the frame 14, the printing press 10 can be converted from having the first print length to the second print length.

The sub-frame 24 is mounted to the frame 14 in any suitable manner so that the bores 39a and 39b of the sub-frame 24 properly align with the bores 37a and 37b of the frame 14 as described above and as will be described in detail below. The frame 14 and/or the sub-frame 24 may include a number of reference lines, surfaces, projections, or the like that provide the proper aligning of the sub-frame 24 and the frame 14. For example, each of the frame sides 14a and 14b can include a plurality of dowels (not shown) that receive a corresponding number of apertures on the sub-frame sides 24a and 24b, respectively, to properly align the sub-frame 24 with the frame 14. In another example, each of the frame sides 14a and 14b can include a shallow depression (not shown) that is about the size of each of the sub-frame sides 24a and 24b. Accordingly, each sub-frame side 24a and 24b can be placed in the a corresponding depression for proper alignment with the frame sides 14a and 14b, respectively. In the disclosed example, the frame 14 includes or may otherwise be provided with one or more datum surfaces 28a, 28b. The datum surface 28a is generally vertical, while the datum surface 28b is generally horizontal. According to the disclosed example, the datum surfaces 28a and 28b may be used in order to properly vertically and horizontally align the sub-frame 24 relative to the frame 14 of the printing press 10.

Once each of the sub-frame sides 24a and 24b are aligned with the frame sides 14a and 14b, the sub-frame sides 24a and 24b can be securely fastened to the frame sides 14a and 14b with bolts 26, pins (not shown), or other types of fasteners. One of ordinary skill in the art will readily recognize that the bolts 26 and a corresponding number of apertures in the frame 14 and/or the sub-frame 24 that support the bolts 26 can also be used to align the sub-frame sides 24a, 24b with the frame sides 14a, 14b.

Referring to FIG. 1, the printing station 12a includes a pair of plate cylinders 16a and 16b and a pair of blanket cylinders 18a and 18b, which my be generally and collectively referred to herein as printing cylinders. The plate cylinders 16a and 16b and the blanket cylinders 18a and 18b straddle a path A along which the paper web (not shown) travels. The printing station 12a also includes an ink roller train 20a, which in the disclosed example consists of five individual rollers, and a dampening system 22a, which in the disclosed example consists of two individual rollers. The ink roller train 20a and the dampening system 22a are associated with the plate cylinder 16a and the blanket cylinder 18a. Similarly, the printing station 12b includes an ink roller train 20b, which in the disclosed example includes five individual rollers, and also includes a dampening system 22b, which in the disclosed example includes two individual rollers.

The ink roller train 20b and the dampening system 22b are associated with the plate cylinder 16b and the blanket cylinder 18b. It will be understood that the precise details of the ink roller trains 20a, 20b and the dampening systems 22a and 22b may vary in accordance with the requirements of any given printing press. Similarly, it will be understood that the printing press 10 may include additional components (no shown) which are known to those of skill in the art. Also, the printing station 12b may be substantially similar to the printing station 12a described above, and therefore in the interest of brevity the printing station 12b need not be described in detail herein.

Referring to FIG. 2, because the printing cylinders of the printing press 10 may have very similar or identical structures, only one of the printing cylinders, namely the plate cylinder 16a is shown in detail and will be described in the following. The plate cylinder 16a includes a shaft 17 having a first shaft end 19a and a second shaft end 19b. The second shaft end 19b may be a drive end. The shaft ends 19a and 19b include shaft end bearing assemblies 36a and 36b, respectively. Each shaft end bearing assembly 36a and 36b includes a bearing 34a and 34b, respectively. Each of the shaft end bearing assemblies 36a and 36b also includes an eccentric mounting sleeve 30a and 30b, respectively. Similarly, as shown in FIG. 1, each of the blanket cylinders 18a and 18b can include an eccentric mounting sleeve 32a and 32b, respectively.

The shaft end bearing assemblies 36a and 36b of the plate cylinder 16a are mounted to the sub-frame 24 using a split-side retainer 38 (only one retainer 38 is shown in FIG. 2). The retainer 38 may include two halves 38a, 38b, which, when joined together, form a generally doughnut-shaped retainer. The bearings 34a and 34b along with the sleeves 30a and 30b may slide axially relative to the cylinder 16a to permit installation of the cylinder 16a on the sub-frame 24. The retainers 38 serve to properly position the bearings axially on the cylinder 16a and to secure the sleeves 30a and 30b to the sub-frame 24.

The sub-frame 24 is configured to permit the print cylinders to swing between the two configurations shown in FIG. 2. For example, the sub-frame 24 may include an appropriate slot 40 sized to permit the eccentric sleeve 30a and the bearing 34a to be moved out of the sub-frame 24 as shown in FIG. 2. Thus, when the sleeves 30a, 30b and/or the bearings 34a, 34b are shifted toward the center of the cylinder 16a, the ends 19a, 19b may be positioned through the bores 39a and 39b, and possibly through the bores 37a and 37b, thus allowing the cylinder 16a to be positioned as shown in FIG. 2. Subsequently, the sleeves and the bearings are shifted outwardly such that they may be mounted to the sub-frame 24 and secured using the retainer 38.

In accordance with disclosed example, wherein the printing press 10 is an existing printing press 10, the printing press 10 may be converted from its original printing length to a different print length, while the frame 14 of the printing press 10, the main drive train (not shown), the ink roller train 20a and 20b, and the dampening systems 22a and 22b remain essentially intact. In other words, those systems in place on the printing press 10 prior to incorporating the apparatus of the present disclosure need not be replaced. Therefore, modifying an existing printing press 10 in accordance with the teachings of the present disclosure saves significantly on the cost of dismantling, shipping, and assembly, and a significant amount of parts, systems, and sub-structures remain in place and/or are reused after the printing press has been modified with the new printing length/cutoff. Further, most if not all of the electrical wiring, piping and ducting in place on the existing printing press may also remain undisturbed.

In accordance with the disclosed examples, to modify the existing printing press 10 from its original print length to a different print length, the sub-frame 24 having the sides 24a and 24b may be mounted on the existing frame 14 of the printing press 10. Prior to mounting the sub-frame 24 to the frame 14, however, the print cylinders of the frame 14, which are all sized to provide the first print length, are removed from the frame 14. The sides 24a and 24b of the sub-frame can be mounted to the sides 14a and 14b, respectively, of the frame 14. The sides 24a and 24b of the sub-frame 24 may be located precisely both vertically and horizontally and relative to each other, using the above described datum surfaces 28a and 28b. The sides 24a and 24b of the sub-frame 24 may be suitably fastened to the corresponding sides 24a and 24b of the frame 24 with pins, bolts or other types of fasteners.

When the sub-frame 24 is mounted to the frame 14, the bores 39a and 39b of the sub-frame 24 may align with the bores 37a and 37b of the frame 24, respectively. However, the bores 39a and 39b may not align concentrically with the bores 37a and 37b of the frame 14. In other words, the common bore axis 60 of the bores 39a and 39b may not align with the common bore axis 60 of the corresponding bores 37a and 37b. Accordingly, when the print cylinders having a print length of the second size are mounted on the sub-frame 24, the shaft end bearing assemblies 36a and 36b of the print cylinders are operatively mounted in the bores 39a and 39b of the sub-frame 24. However, because the bores 39a and 39b of the sub-frame 24 may be aligned with the bores 37a and 37b of the frame 14, the shaft ends 19a and 19b of the print cylinders can extend into the bores 37a and 37b of the frame 14. As shown in FIG. 2, such extension of the shaft end 19b may be necessary since the shaft end 19b is the driven end of the shaft 17 and may be connected to a drive source.

After the sub-frame 24 is mounted to the frame 14, the printing cylinders having the second print length can be mounted to the sub-frame 24 as shown in FIG. 2. Each print cylinder can be mounted in the sub-frame 24 by first inserting the second shaft end 19b in the bore 39b of the sub-frame 24. It may be necessary, however, to first slide the bearing assemblies 36a and 36b toward the center of the print cylinder. The first shaft end 19a, which includes the bearing assembly 36a can be swung into the bore 39a through the slot 40, as described above. The bearing assemblies 36a and 36b can be moved outward from the center of the printing cylinder and positioned in the bores 39a and 39b, respectively. The eccentric sleeves 30a and 30b can then be adjusted to provide the proper operative coupling between the printing cylinders. The split retainer 38 may then be installed over the bearing assembly 36a and bolted to the appropriate eccentric mounting sleeve 30a in order to properly locate the bearing 34a within the sleeve 30a. A separate retainer (not shown) may be installed at the opposite end of the cylinder to hold the bearing 34b and the sleeve 30b at the shaft end 19b in place in a similar manner.

In accordance with another aspect of the disclosed example, much if not all of the main drive (not shown) may be retained intact or nearly intact. New gearing appropriate for the new cylinders may be provided as needed. Adapter plates and/or eccentric sleeves/studs may be used to reposition gears to accommodate the position of the existing main drive gear.

In accordance with yet another aspect of the disclosed example, a printing press 10 can be provided with a number of sub-frames 24. Each sub-frame 24 can include a plurality of bores that can support print cylinders having a print length that is different than the print length of the existing printing press 10 and the other sub-frames 24. Accordingly, the printing press 10 is readily adaptable for conversion to different printing lengths in accordance with the number of sub-frames 24 provided. Each sub-frame 24 can be mounted to the frame 14 of the printing press 10 as described in the foregoing to change the print length of the printing press 10.

Numerous modifications and alternative embodiments of the invention will be apparent to those skilled in the art in view of the forgoing description. Accordingly, this description is to be construed as illustrative only and is for the purpose of teaching those skilled in the art the best mode of carrying out the invention. The details of the system may be varied substantially without departing from the spirit of the invention, and the exclusive use of all modifications which are within the scope of the claims is reserved.

What is claimed is:

1. A printing press comprising:
a frame having a plurality of bores relatively positioned on the frame to support a plurality of operatively coupled printing cylinders of a first size;
a sub-frame having a plurality of bores relatively positioned on the sub-frame to support a plurality of operatively coupled printing cylinders of a second size; and
wherein the sub-frame is mountable to the frame to convert the printing press from operating with the printing cylinders of the first size to the printing cylinders of the second size.

2. The printing press of claim 1, the frame comprising a generally horizontal datum surface and a generally vertical datum surface, wherein the sub-frame is mounted to the frame by being aligned with the horizontal datum surface and the vertical datum surface.

3. The printing press of claim 1, further comprising means for aligning the sub-frame with the frame to mount the sub-frame to the frame.

4. The printing press of claim 1, wherein the sub-frame is securely mounted to the frame with a plurality of fasteners.

5. The printing press of claim 1, the frame comprising a first frame side and a second frame side, and the sub-frame comprising a first sub-frame side and a second sub-frame side, wherein the first sub-frame side is securely mounted to the first frame side and the second sub-frame side is securely mounted to the second frame side.

6. The printing press of claim 5, wherein each bore of the first sub-frame side includes a slot connecting the bore to an outside of the sub-frame, and wherein the slot is sized to provide pivotal mounting of a shaft end bearing assembly of any of the printing cylinders from the outside of the sub-frame into the bore and pivotal removal of the shaft end bearing assembly from the bore to the outside of the sub-frame.

7. A sub-frame for use with a frame of a printing press, the sub-frame comprising:
a first sub-frame side having a plurality of bores;
a second sub-frame side spaced apart from the first sub-frame side, the second sub-frame side having a plurality of bores, each bore of the first sub-frame side and a corresponding one of the bores of the second sub-frame side aligned by a common bore axis to support a printing cylinder; and
each common bore axis of the sub-frame is disposed on the sub-frame so as to be offset relative to a corresponding common bore axis of the frame when the first sub-frame side and the second sub-frame side are mounted to the frame.

8. The sub-frame of claim 7, wherein the first sub-frame side and the second sub-frame side provide support for a plurality of operatively coupled printing cylinders having different sizes relative to a plurality of operatively coupled printing cylinders being supportable by the frame.

9. The sub-frame of claim 7, wherein the first sub-frame side and the second sub-frame side are mounted to the frame by being aligned with a generally horizontal datum surface and a generally vertical datum surface of the frame.

10. The sub-frame of claim 7, wherein the first sub-frame side and the second sub-frame side are mounted to the frame by being aligned with the frame with a means for aligning the sub-frame with the frame.

11. The sub-frame of claim 7, wherein the first sub-frame side and the second sub-frame side are fastened to the frame with a plurality of fasteners.

12. The sub-frame of claim 7, wherein each bore of the first sub-frame side includes a slot connecting the bore to an outside of the sub-frame, and wherein the slot is sized to provide mounting of a shaft end bearing assembly of a printing cylinder from the outside of the sub-frame into the bore through the slot and removal of the shaft end bearing assembly from the bore to the outside of the sub-frame through the slot.

13. The sub-frame of claim 7, the printing cylinder including a first bearing assembly supportable in a bore of the first sub-frame side and a second bearing assembly supportable in the corresponding bore of a second sub-frame side, wherein the first bearing assembly and the second bearing assembly are shiftable toward a center of the printing cylinder.

14. The sub-frame of claim 13, each of the first bearing assembly and the second bearing assembly comprising a bearing disposed in a sleeve to provide rotation of the printing cylinder relative to the sleeve, wherein the sleeve is eccentric relative to shaft of the print cylinder.

15. The sub-frame of claim 13, the printing cylinder comprising a retainer to securely retain at least one of the first bearing assembly or the second bearing assembly in a corresponding bore of the sub-frame.

16. A method to use a plurality of print cylinders of a second size in a printing press having a plurality of print cylinders of a first size, the method comprising:
removing the print cylinders of the first size from a frame, the frame having a plurality of spaced apart frame bores, each pair of spaced apart frame bores having a common bore axis to support and operatively couple the print cylinders of the first size;
mounting a sub-frame to the frame, the sub-frame including a plurality of spaced apart sub-frame bores, each pair of spaced apart sub-frame bores having a common bore axis to support and operatively couple the print cylinders of the second size; and
mounting each of the print cylinders of the second size in the sub-frame, the mounting including mounting shaft end bearing assemblies of each print cylinder of the second size in a pair of the spaced apart bores of the sub-frame.

17. The method of claim 16, the mounting of the sub-frame to the frame comprising aligning the sub-frame with the frame and fastening the sub-frame to the frame.

18. The method of claim 16, the mounting of the sub-frame to the frame comprising mounting a first sub-frame side to a first frame side and mounting a second sub-frame side to a second frame side.

19. The method of claim 18, the mounting of each of the print cylinders of the second size in the sub-frame comprising mounting one of the shaft end bearing assemblies of each print cylinder of the second size in a bore of the first sub-frame side through a slot connecting the bore to an outside of the sub-frame.

20. The method of claim 16, the mounting of each of the print cylinders of the second size in the sub-frame comprising mounting one of the shaft end bearing assemblies of each print cylinder of the second size in a bore of the sub-frame through a slot connecting the bore to an outside of the sub-frame.

21. A printing press comprising:
a frame having a plurality of bores relatively positioned on the frame to support a plurality of operatively coupled printing cylinders having an original print length;
a plurality of sub-frames, each sub-frame having a plurality of bores relatively positioned on the sub-frame to support a plurality of operatively coupled printing cylinders having a different print length than the original print length and a different print length than a print length of a plurality of cylinders supported by the other sub-frames; and
wherein each sub-frame is mountable to the frame to convert the printing press from operating with the printing cylinders having the original print length to the printing cylinders having the print length supported by the sub-frame.

22. The printing press of claim 21, the frame comprising a generally horizontal datum surface and a generally vertical datum surface, wherein each sub-frame is mounted to the frame by being aligned with the horizontal datum surface and the vertical datum surface.

23. The printing press of claim 21, further comprising means for aligning each sub-frame with the frame to mount the sub-frame to the frame.

24. The printing press of claim 21, wherein each sub-frame is securely mounted to the frame with a plurality of fasteners.

25. The printing press of claim 21, the frame comprising a first frame side and a second frame side, and each sub-frame comprising a first sub-frame side and a second sub-frame side, wherein the first sub-frame side of each sub-frame is securely mounted to the first frame side and the second sub-frame side of each sub-frame is securely mounted to the second frame side.

26. The printing press of claim 25, wherein each bore of the first sub-frame side of each sub-frame includes a slot connecting the bore to an outside of the sub-frame, and wherein the slot is sized to provide pivotal mounting of a shaft end bearing assembly of any of the printing cylinders from the outside of the sub-frame into the bore and pivotal removal of the shaft end bearing assembly from the bore to the outside of the sub-frame.
